(19) United States
(12) Patent Application Publication
(10) Pub. No.: US 2025/0023008 A1
(43) Pub. Date: Jan. 16, 2025

(54) BATTERY BONDING DEVICE

(71) Applicant: SK On Co., Ltd., Seoul (KR)

(72) Inventors: Hyun Min JEON, Daejeon (KR); Seung Hyun KIM, Daejeon (KR)

(21) Appl. No.: 18/747,460

(22) Filed: Jun. 19, 2024

(30) Foreign Application Priority Data
Jul. 12, 2023 (KR) 10-2023-0090405
Nov. 22, 2023 (KR) 10-2023-0163278

(51) Int. Cl. H01M 4/04; G01F 1/667

(52) U.S. Cl. CPC H01M 4/04; G01F 1/667

(57) ABSTRACT

A battery bonding device according to the present disclosure includes an injection portion discharging an adhesive to bond an electrode assembly, a flow sensor detecting a flow rate of an adhesive supplied to the injecting portion, and a control portion determining whether the electrode assembly is defective according to the flow rate.

### CROSS-REFERENCE TO RELATED PATENT APPLICATION

The present application claims priority under 35 U.S.C. § 119 (a) to Korean patent application number 10-2023-0090405 filed on Jul. 12, 2023 and Korean patent application number 10-2023-0163278 filed on Nov. 22, 2023, in the Korean Intellectual Property Office, the entire disclosure of which is incorporated by reference herein.

### BACKGROUND OF THE INVENTION

### 1. Field

The present disclosure relates to a battery cells and a manufacturing methods of the same. Specifically, it relates to a battery cell having a groove-shaped notch portion and a method of manufacturing the same.

### 2. Description of the Related Art

A secondary battery is a battery that may be charged and discharged multiple times. Secondary batteries may be classified into a pouch type, a prismatic type, a cylindrical type, etc.

A secondary battery may be bonded using an adhesive during the manufacturing process. There is a method in which an operator visually confirms the amount of adhesive discharged to determine whether bonding of a secondary battery is defective, but there is a problem that the criteria vary depending on the operators or the determination is not accurate, and ways to solve this problem are being sought.

### SUMMARY OF THE INVENTION

The present disclosure is intended to provide a battery bonding device that accurately detects the discharged amount of an adhesive.

The present disclosure may be widely applied to green technology such as photovoltaics and wind power generation. In addition, the present disclosure may be applied to eco-friendly devices such as electric vehicles and hybrid vehicles to prevent climate change by suppressing air pollution and greenhouse gas emissions.

A battery bonding device according to an embodiment may include an injection portion discharging an adhesive to bond an electrode assembly; a flow sensor detecting a flow rate of an adhesive supplied to the injecting portion; and a control portion determining whether the electrode assembly is defective according to the flow rate.

In an embodiment, a battery bonding device may further include a storage portion storing the adhesive; and a pipe connecting the storage portion and the injection portion and supplying the adhesive from the storage portion to the injection portion.

In an embodiment, a flow sensor may be fixed to an outer surface of the pipe.

In an embodiment, a flow sensor may include a first transceiver portion and a second transceiver portion, wherein the second transceiver portion is disposed to have an inclination of a set angle with respect to a flow velocity direction of an adhesive based on the first transceiver portion.

In an embodiment, a first transceiver portion may transmit a first ultrasonic wave toward a second transceiver portion, and the second transceiver portion transmits a second ultrasonic wave toward the first transceiver portion.

In an embodiment, a flow sensor may calculate a flow velocity of an adhesive based on a difference between a reception time of a first ultrasonic wave received by a second transceiver portion and a reception time of a second ultrasonic wave received by a first transceiver portion.

In an embodiment, a flow sensor may calculate a flow rate using a flow velocity and a cross-sectional area of a pipe.

In an embodiment, a control portion may determine an electrode assembly to be defective when a flow rate is greater than a reference upper limit value or smaller than a reference lower limit value and determines an electrode assembly to be normal when the flow rate is smaller than or equal to the reference upper limit value and greater than or equal to the reference lower limit value.

In an embodiment, the injection portion may adjust an amount of adhesive to be discharged according to a flow rate set value, and a control portion determines whether an electrode assembly is defective based on a difference between the flow rate set value and a flow rate.

In an embodiment, a battery bonding device may further include an output portion displaying an alarm or outputting an alarm sound when an electrode assembly is determined to be defective by the control portion.

In an embodiment, in an internal separator and a bonding finishing portion included in a separator of an electrode assembly, an injection portion may discharge an adhesive onto at least a part of the bonding finishing portion.

In an embodiment, in a first bonding finishing portion in a wound state included in a bonding finishing portion, an injection portion may discharge an adhesive onto at least a part of an area in which a second bonding finishing portion included in the bonding finishing portion and connected to one end of the first bonding finishing portion is to be wound.

The present disclosure can provide a battery bonding device that accurately detects a discharged amount of an adhesive.

A battery bonding device of the present disclosure can accurately determine whether bonding of a secondary battery is defective.

### BRIEF DESCRIPTION OF THE DRAWINGS

FIG. 1 is a block diagram for explaining a battery bonding device according to an embodiment.

FIG. 2 is a diagram for explaining a battery bonding device according to an embodiment.

FIG. 3 is a diagram for explaining a flow sensor according to an embodiment.

FIGS. 4 to 6 are diagrams for explaining an electrode assembly of a secondary battery according to an embodiment.

### DETAILED DESCRIPTION

The structural or functional descriptions of embodiments disclosed in the present specification or application are merely illustrated for the purpose of explaining embodiments according to the technical principle of the present invention, and embodiments according to the technical principle of the present invention may be implemented in various forms in addition to the embodiments disclosed in the specification of application. In addition, the technical principle of the present invention is not construed as being limited to the embodiments described in the present specification or application.

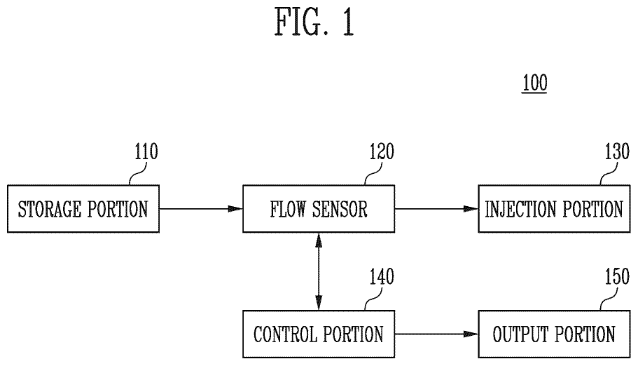

FIG. 1 is a block diagram for explaining a battery bonding device according to an embodiment.

Referring to FIG. 1, a battery bonding device 100 according to an embodiment may include a storage portion 110, a flow sensor 120, an injection portion 130, a control portion 140, and an output portion 150. For example, a battery bonding device 100 may be a secondary battery manufacturing facility.

A storage portion 110 may store an adhesive in an inner space. Here, the adhesive may be a liquid polymer material. A storage portion 110 may provide an adhesive to an injection portion 130.

An injection portion 130 may discharge an adhesive supplied from a storage portion 110. An adhesive discharged between objects may be hardened and may bond the objects to each other.

An injection portion 130 may discharge an adhesive to an electrode assembly of a secondary battery to bond the electrode assembly. In an embodiment, an injection portion 130 may discharge an adhesive onto a part of an outermost separator of an electrode assembly. The adhesive may be hardened while another part of the outermost separator covers the discharged adhesive, allowing the outermost separator to be joined.

A flow sensor 120 may detect a flow rate of an adhesive supplied to an injection portion 130. A flow rate may represent an amount (e.g., volume or mass, etc.) in which an adhesive moves during a certain period of time. In an embodiment, detecting a flow rate may mean obtaining a flow rate in a direct manner or obtaining a flow rate in an indirect manner. For example, a flow rate may be obtained directly by a flow sensor 120. For another example, a flow rate may be obtained using other sensing values (e.g., time, flow velocity, etc.) of a flow sensor 120. In this case, a flow sensor 120 may obtain a flow rate using a sensing value of a flow sensor 120 or a control portion 140 may obtain a flow rate using a sensing value of a flow sensor 120.

A control portion 140 may determine whether an electrode assembly is defective according to a flow rate. A flow rate may be a value obtained by a flow sensor 120. A control portion 140 may control an output portion 150 to output an alarm when an electrode assembly is determined to be defective.

An output portion 150 may output an alarm when an electrode assembly is determined to be defective. An output portion 150 may include a display or a speaker. A display may display an alarm as visual information. A speaker may output a notification through sound waves as auditory information.

As described above, a battery bonding device 100 of the present disclosure may accurately determine bonding defects by accurately detecting a flow rate or a discharged amount of an adhesive. A battery bonding device 100 may prevent an electrode assembly determined to be defective from being put into a subsequent process. Hereinafter, specific embodiments of the present disclosure will be described.

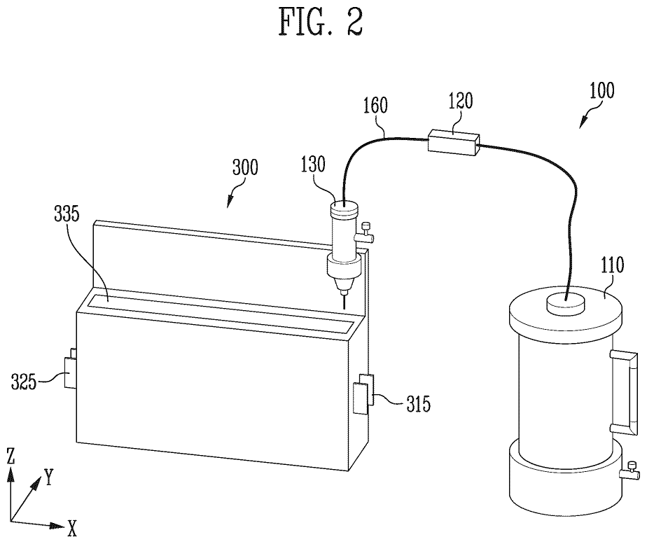

FIG. 2 is a diagram for explaining a battery bonding device according to an embodiment.

Referring to FIGS. 1 and 2, a battery bonding device 100 according to an embodiment may apply an adhesive to a bonding finishing portion 335 of an electrode assembly 300.

Specifically, a storage portion 110 may store an adhesive. A battery bonding device 100 according to an embodiment may further include a pipe 160. In an embodiment, a pipe 160 may include at least one material among a metal and a resin. A pipe 160 may connect a storage portion 110 and an injection portion 130. A pipe 160 may supply an adhesive 50 from a storage portion 110 to an injection portion 130. In other words, a storage portion 110 may be connected to an injection portion 130 through a pipe 160. A storage portion 110 may supply an adhesive to an injection portion 130 through a pipe 160.

An injection portion 130 may discharge an adhesive supplied from a storage portion 110. When an injection portion 130 discharges an adhesive, the injection portion 130 may receive an adhesive from a storage portion 110 again. In other words, a discharged amount of an adhesive may be a flow rate of an adhesive supplied from a storage portion 110 to an injection portion 130.

An injection portion 130 may discharge an adhesive to bond a bonding finishing portion 335 of an electrode assembly 300 of a secondary battery. In other words, an injection portion 130 may apply an adhesive to a bonding finishing portion 335 of an electrode assembly 300. Here, the electrode assembly 300 may be an assembly in which a first electrode, a second electrode, and a separator are stacked in a stacking direction (e.g., Y-axis direction). A first electrode and a second electrode may have different polarities. For example, a first electrode may be an anode, and a second electrode may be a cathode. For another example, a first electrode may be a cathode, and a second electrode may be an anode. A first electrode may include a first electrode tab 315 protruding in one direction (e.g., +X-axis direction), and a second electrode may include a second electrode tab protruding in another direction (e.g., −X-axis direction). However, not being limited thereto depending on embodiments, a first electrode and a second electrode may each include electrode tabs protruding in the same direction (e.g., +X-axis direction). A separator may separate a plurality of first electrodes and a plurality of second electrodes from each other. In other words, a separator may prevent direct contact between a first electrode and a second electrode to prevent the first electrode and the second electrode from being short-circuited. In the present specification, bonding an electrode assembly 300 may include fixing a part of a separator to another part of the separator.

In an embodiment, an injection portion 130 may include a mechanical portion capable of linear or rotational movement and a motor transmitting a driving force to the mechanical portion. For example, referring to FIG. 2, an injection portion 130 may move in the +X-axis direction or the −X-axis direction. An injection portion 130 may start discharging an adhesive at a first set position, and the injection portion 130 may continue discharging the adhesive while moving from the first set position to a second set position. The injection portion 130 may stop discharging the adhesive when moved to the second set position. In an embodiment, the injection portion 130 may include an injection port and a pestle. A pestle may move upward or downward depending on whether air is injected. When a pestle moves upward, an injection port may be opened, and an adhesive may be discharged. When a pestle moves downward, an injection port may be closed and discharging of an adhesive may be discontinued.

In an embodiment, a flow sensor 120 may be fixed to an outer surface of a pipe 160. For example, a flow sensor 120 may be fixed to an outer surface of a pipe 160 through a clamp. In this case, the flow sensor 120 may detect a flow rate of an adhesive moving in an inner space of the pipe 160 without being in contact with the adhesive. That is, the flow sensor 120 may detect a flow rate of the adhesive in a non-contact manner. In an embodiment, a flow rate may be a volume per unit time, such as mL/sec, but may be modified into various types of physical quantities.

In an embodiment, a control portion 140 may determine an electrode assembly 300 to be defective when a flow rate is greater than a reference upper limit value or smaller than a reference lower limit value. A control portion 140 may determine an electrode assembly 300 to be normal when a flow rate is smaller than or equal to a reference upper limit value and greater than or equal to a reference lower limit value. A reference upper limit value may be a value greater than a reference lower limit value. A reference upper limit value and a reference lower limit value may be preset values.

In an embodiment, an injection portion 130 may adjust an amount of adhesive to be discharged according to a flow rate set value. For example, a flow rate set value may be a preset value as a control value (or expected value) for setting an amount of adhesive to be discharged. In this case, a control portion 140 may determine whether an electrode assembly 300 is defective based on a difference between a flow rate set value and a flow rate. For example, when a difference between a flow rate set value and a flow rate exceeds a reference value, a control portion 140 may determine that an electrode assembly 300 is defective. For example, when a difference between a flow rate set value and a flow rate is smaller than a reference value, a control portion 140 may determine that an electrode assembly 300 is normal. Here, the reference value may be a preset value. For example, the reference value may be various values such as 0.01 or 0.02.

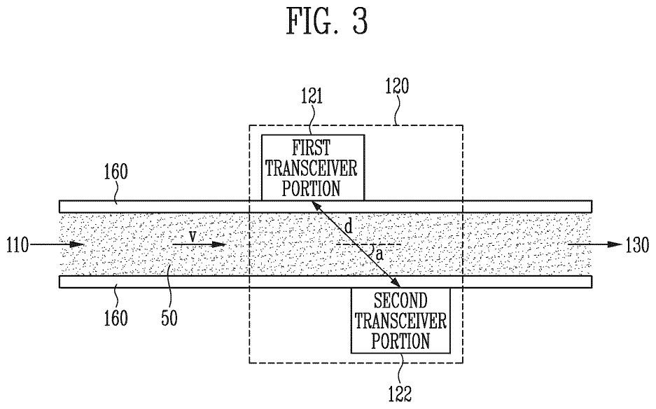

FIG. 3 is a diagram for explaining a flow sensor according to an embodiment.

Referring to FIG. 3, a flow sensor 120 according to an embodiment may be installed on an outer surface of a pipe 160. Here, a flow sensor 120 may be an ultrasonic sensor. However, this is only an example, and the type of flow sensor 120 is not limited thereto and may be implemented in various modifications. While an injection portion 130 discharges an adhesive, the adhesive 50 may be moved from a storage portion 110 to the injection portion 130 through an inner space of a pipe 160.

In an embodiment, a flow sensor 120 may include a first transceiver portion 121 and a second transceiver portion 122 disposed with a pipe 160 interposed therebetween. A second transceiver portion 122 may be disposed to have an inclination of a set angle (a) with respect to a flow velocity direction of an adhesive 50 based on a first transceiver portion 121. Here, the flow velocity direction may be a direction parallel to a pipe 160 or a longitudinal direction of the pipe 160. A set angle (a) may be greater than 0 degrees and less than 90 degrees. An outer diameter of a pipe 160 may be distance (d) x sin (a) between a first transceiver portion 121 and the second transceiver portion 122. That is, a distance d between a first transceiver portion 121 and a second transceiver portion 122 may be longer than an outer diameter of a pipe 160.

In an embodiment, a first transceiver portion 121 may transmit a first ultrasonic wave toward a second transceiver portion 122. A second transceiver portion 122 may transmit a second ultrasonic wave toward a first transceiver portion 121. Each of a first transceiver portion 121 portion and a second transceiver portion 122 may transmit or receive a ultrasonic wave. To this end, each of a first transceiver portion 121 and a second transceiver portion 122 may include an ultrasonic wave transmitter and an ultrasonic wave receiver.

In an embodiment, a flow rate sensor 120 may calculate a flow velocity (v) of an adhesive 50 based on a difference between a reception time of a first ultrasonic wave received by a second transceiver portion 122 and a reception time of a second ultrasonic wave received by a first transceiver portion 121.

In an embodiment, a flow sensor 120 may calculate a flow rate (v) of adhesive 50 using Equation 1 below.

$$v = \frac{{c}^{2}}{Δ t \times 2 d \times cos ( a )}$$

Here, c may be a velocity of a ultrasonic wave passing through an adhesive. Δt may be a difference between a reception time of a first ultrasonic wave received by a second transceiver portion 122 and a reception time of a second ultrasonic wave received by a first transceiver portion 121. In addition, d may be a distance between a first transceiver portion 121 and a second transceiver portion 122, and a may be a set angle.

In an embodiment, a flow sensor 120 may calculate a flow rate of an adhesive 50 using a flow velocity v of the adhesive 50 and a cross-sectional area of a pipe 160. For example, a flow sensor 120 may obtain a value obtained by multiplying a flow velocity (v) of an adhesive 50 by a cross-sectional area of a pipe 160 as a flow rate. A cross-sectional area of a pipe 160 may be a value measured in advance. Meanwhile, the above-described embodiment is only an example, and a flow rate of an adhesive 50 may be detected in various ways.

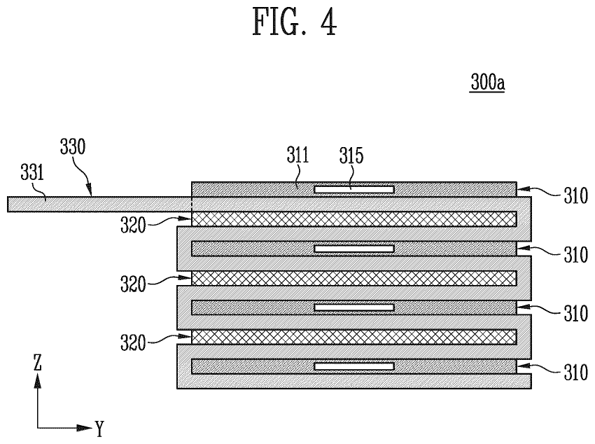

FIGS. 4 to 6 are diagrams for explaining an electrode assembly of a secondary battery according to an embodiment. FIGS. 4 to 6 show a process of manufacturing an electrode assembly in a chronological order from one side of the electrode assembly.

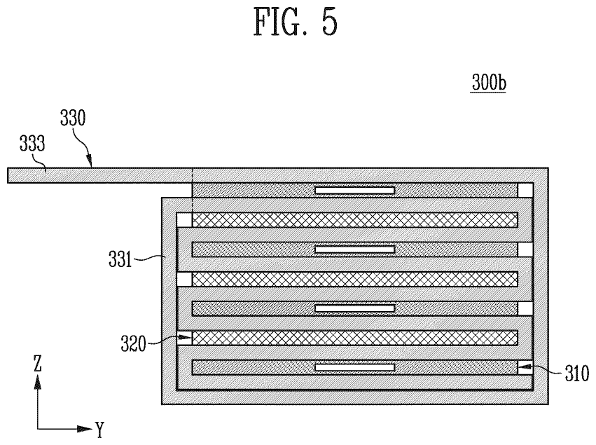

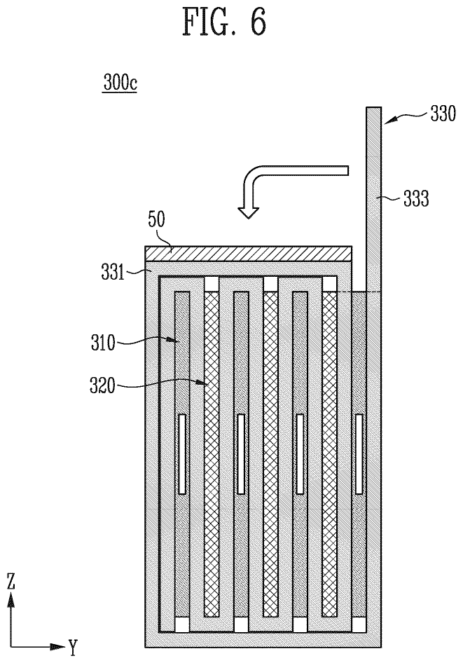

FIG. 4 shows a process of stacking an electrode assembly 300a, FIG. 5 shows a process of winding an electrode assembly 300b, and FIG. 6 shows a process of applying an adhesive 50 by rotating an electrode assembly 300c.

Referring to FIG. 4, an electrode assembly 300a may be formed by repeatedly stacking

a first electrode 310, a second electrode 320, and a separator 330 in a vertical direction (e.g., Z-axis direction). That is, an electrode assembly 300a may include a first electrode 310, a second electrode 320, and a separator 330.

A first electrode 310 and a second electrode 320 may be electrodes with different polarities. For example, a first electrode 310 may be an anode, and a second electrode 320 may be a cathode. A first electrode 310 may include a first electrode plate 311 and a first electrode tab 315 protruding in one direction (e.g., +X-axis direction) from one side end of the first electrode plate 311, and a second electrode may include a second electrode plate and a second electrode tab 325 protruding in another direction (e.g., −X-axis direction) from the second electrode. A first electrode 310 and a second electrode 320 may each include a conductive material.

A separator 330 may be disposed between a first electrode 310 and a second electrode 320 so that the first electrode 310 and the second electrode 320 do not contact each other. In an embodiment, a separator 330 may be stacked in an integrated form in a Z-stacking manner in which the separator is folded at ends of each of a first electrode 310 and a second electrode 320. In another embodiment, a separator 330 may be stacked in a form of multiple segments in a manner in which the separator is disposed between a first electrode 310 and a second electrode 320. A separator 330 may include an insulating material.

In an embodiment, a separator 330 may include an internal separator and a bonding finishing portion. In other words, an internal separator and a bonding finishing portion may be part of a separator 330. In an embodiment, an injection portion 130 may discharge an adhesive to at least a part of a bonding finishing portion. In an embodiment, an internal separator and a bonding finishing portion may be integrally connected. In another embodiment, an internal separator and a bonding finishing portion may be parts that are disconnected from each other. A bonding finishing portion may be a part that is wound on an electrode assembly basis, and an internal separator may be a part that is wound on an electrode basis or a part that is interposed between electrodes. In an embodiment, a bonding finishing portion may include a first bonding finishing portion 331 and a second bonding finishing portion 333 (see FIG. 5). A first bonding finishing portion 331 may be a part protruding in a horizontal direction (e.g., Y-axis direction) from one end of an internal separator disposed below an uppermost electrode of an electrode assembly 300a. In other words, one end of a first bonding finishing portion 331 may be connected to an internal separator.

In addition, a first bonding finishing portion 331 may be wound to surround an outer surface of an electrode assembly 300a in a stacked state. Here, the first bonding finishing portion 331 may be wound to surround side, bottom, and top surfaces of the electrode assembly 300a in a stacked state. Referring to FIGS. 4 and 5, an electrode assembly 300b of FIG. 5 shows a state after the electrode assembly 300a of FIG. 4 is wound. Here, a second bonding finishing portion 333 may be a part protruding from the first bonding finishing portion 331 in one direction. In other words, a second bonding end portion 333 may be connected to the other end of a first bonding end portion 331.

An electrode assembly 300b may be rotated 90 degrees with the X axis as an axis of rotation. Referring to FIGS. 5 and 6, an electrode assembly 300c of FIG. 6 shows a state after the electrode assembly 300b of FIG. 5 is rotated. Here, a part positioned at an outermost part of a separator 330 based on the center may be defined as an outermost separator. In the present specification, an outermost separator may refer to a part of a separator that is integrally connected to an internal separator disposed between a first electrode and a second electrode and surrounding the internal separator. For example, an outermost separator may correspond to a part of a bonding finishing portion.

In an embodiment, an injection portion 130 of a battery bonding device 100 may discharge an adhesive 50 into one area of a first bonding finishing portion 331 of an electrode assembly 300. In other words, an adhesive 50 may be applied to one area of a first bonding finishing portion 331 by an injection portion 130.

In an embodiment, a first bonding finishing portion 331 may be in a wound state in which the first bonding finishing portion surrounds a first electrode 310, a second electrode 320, and an outside of an internal separator. In an embodiment, one area of a first bonding finishing portion 331 may be at least a part of an area to be covered by winding a second bonding finishing portion 333. In other words, at least a part of a second bonding end portion 333 that has been wound may be positioned outside a first bonding finishing portion 331. Here, the second bonding finishing portion 333 may be wound in the same direction as the first bonding finishing portion 331 (e.g., clockwise or counterclockwise). In addition, when an electrode assembly 300c is determined to be normal, a second bonding finishing portion 333 may be wound and cover an adhesive 50 so that an electrode assembly 300c is bonded. In other words, an adhesive 50 may be positioned between a first bonding finishing portion 331 and a second bonding finishing portion 333. On the contrary, when an electrode assembly 300c is determined to be defective, the electrode assembly may be prevented from moving on to a subsequent process.

What is claimed is:

1. A battery bonding device comprising:
an injection portion discharging an adhesive to bond an electrode assembly;
a flow sensor detecting a flow rate of an adhesive supplied to the injecting portion; and
a control portion determining whether the electrode assembly is defective according to the flow rate.

2. The battery bonding device according to claim 1, further comprising:
a storage portion storing the adhesive; and
a pipe connecting the storage portion and the injection portion and supplying the adhesive from the storage portion to the injection portion.

3. The battery bonding device according to claim 2, wherein the flow sensor is fixed to an outer surface of the pipe.

4. The battery bonding device according to claim 3, wherein the flow sensor includes a first transceiver portion and a second transceiver portion,
wherein the second transceiver portion is disposed to have an inclination of a set angle with respect to a flow velocity direction of the adhesive based on the first transceiver portion.

5. The battery bonding device according to claim 4, wherein the first transceiver portion transmits a first ultrasonic wave toward the second transceiver portion, and the second transceiver portion transmits a second ultrasonic wave toward the first transceiver portion.

6. The battery bonding device according to claim 5, wherein the flow sensor calculates a flow velocity of the adhesive based on a difference between a reception time of the first ultrasonic wave received by the second transceiver portion and a reception time of the second ultrasonic wave received by the first transceiver portion.

7. The battery bonding device according to claim 6, wherein the flow sensor calculates the flow rate using a flow velocity and a cross-sectional area of the pipe.

8. The battery bonding device according to claim 1, wherein the control portion determines the electrode assembly to be defective when the flow rate is greater than a reference upper limit value or smaller than a reference lower limit value and determines the electrode assembly to be normal when the flow rate is smaller than or equal to the reference upper limit value and greater than or equal to the reference lower limit value.

9. The battery bonding device according to claim 1, wherein the injection portion adjusts an amount of the adhesive to be discharged according to a flow rate set value, and the control portion determines whether the electrode assembly is defective based on a difference between the flow rate set value and the flow rate.

10. The battery bonding device according to claim 1, further comprising an output portion displaying an alarm or outputting an alarm sound when the electrode assembly is determined to be defective by the control portion.

11. The battery bonding device according to claim 1, wherein in an internal separator and a bonding finishing portion included in a separator of the electrode assembly, the injection portion discharges the adhesive onto at least a part of the bonding finishing portion.

12. The battery bonding device according to claim 11, wherein in a first bonding finishing portion in a wound state included in the bonding finishing portion, the injection portion discharges the adhesive onto at least a part of an area in which a second bonding finishing portion included in the bonding finishing portion and connected to one end of the first bonding finishing portion is to be wound.
